(19) United States
(12) Patent Application Publication
(10) Pub. No.: US 2013/0251288 A1
(43) Pub. Date: Sep. 26, 2013

(54) APPARATUS AND METHOD FOR PROCESSING IMAGE, AND APPARATUS FOR DISPLAYING IMAGE

(71) Applicants: Hisashi KOBIKI, Kanagawa-ken (JP); Yasutoyo Takeyama, Kanagawa-ken (JP); Ryosuke Nonaka, Kanagawa-ken (JP); Masahiro Baba, Kanagawa-ken (JP)

(72) Inventors: Hisashi KOBIKI, Kanagawa-ken (JP); Yasutoyo Takeyama, Kanagawa-ken (JP); Ryosuke Nonaka, Kanagawa-ken (JP); Masahiro Baba, Kanagawa-ken (JP)

(21) Appl. No.: 13/617,541

(22) Filed: Sep. 14, 2012

(30) Foreign Application Priority Data
Mar. 22, 2012 (JP) P2012-066369

(51) Int. Cl. G06K 9/32

(52) U.S. Cl. 382/298

(57) ABSTRACT

According to one embodiment, an image processing apparatus includes a scale down unit, a calculation unit, a scale up unit, and a subtraction unit. The scale down unit generates a scaled down image by scaling down a target image. The scaled down image has a size smaller than the target image. The calculation unit calculates a pixel value of a diffuse reflection component of each pixel in the scaled down image, and generates a first diffuse reflection image having the pixel value and the same size as the scaled down image. The scale up unit generates a second diffuse reflection image by scaling up the first diffuse reflection image. The second diffuse reflection image has the same size as the target image. The subtraction unit generates a specular reflection image by subtracting the second diffuse reflection image from the target image.

### CROSS-REFERENCE TO RELATED APPLICATION

This application is based upon and claims the benefit of priority from Japanese Patent Application No. 2012-066369, filed on Mar. 22, 2012; the entire contents of which are incorporated herein by reference.

### FIELD

Embodiments described herein relate generally to an apparatus and a method for processing an image, and an apparatus for displaying the image.

### BACKGROUND

In order to improve an apparent gloss of a displayed image, by separating a specular reflection component and a diffuse reflection component from an input image, a technique to adjust/control a specular reflection image is necessary. On the other hand, another technique to emphasize a specular reflection image is disclosed. In this technique, by solving simultaneous equations based on dichromatic reflection model, a diffuse reflection image and the specular reflection image are separated from the input image.

As to a conventional technique, in order to separate the diffuse reflection image and the specular reflection, color information of all pixels and other pixels adjacent thereto on the input image is referred. As a result, a calculation amount thereof increases in proportion to a size of the input image.

### BRIEF DESCRIPTION OF THE DRAWINGS

FIG. 1 is a block diagram of an image processing apparatus 10 according to a first embodiment.

FIG. 2 is a flow chart of processing of the image processing apparatus 10.

FIG. 3 is a block diagram of an image processing apparatus 20 according to a second embodiment.

FIG. 4 is a block diagram of an image processing apparatus 30 according to a third embodiment.

FIG. 5 is a flow chart of processing of the image processing apparatus 30.

FIG. 6 is a block diagram of an image processing apparatus 40 according to a fourth embodiment.

FIG. 7 is a block diagram of an image processing apparatus 50 according to a fifth embodiment.

FIG. 8 is a flow chart of processing of the image processing apparatus 50.

FIG. 9 is a block diagram of an image processing apparatus 60 according to a sixth embodiment.

### DETAILED DESCRIPTION

According to one embodiment, an image processing apparatus includes a scale down unit, a calculation unit, a scale up unit, and a subtraction unit. The scale down unit generates a scaled down image by scaling down a target image. The scaled down image has a size smaller than the target image. The calculation unit calculates a pixel value of a diffuse reflection component of each pixel in the scaled down image, and generates a first diffuse reflection image having the pixel value and the same size as the scaled down image. The scale up unit generates a second diffuse reflection image by scaling up the first diffuse reflection image. The second diffuse reflection image has the same size as the target image. The subtraction unit generates a specular reflection image by subtracting the second diffuse reflection image from the target image.

Various embodiments will be described hereinafter with reference to the accompanying drawings.

### The First Embodiment

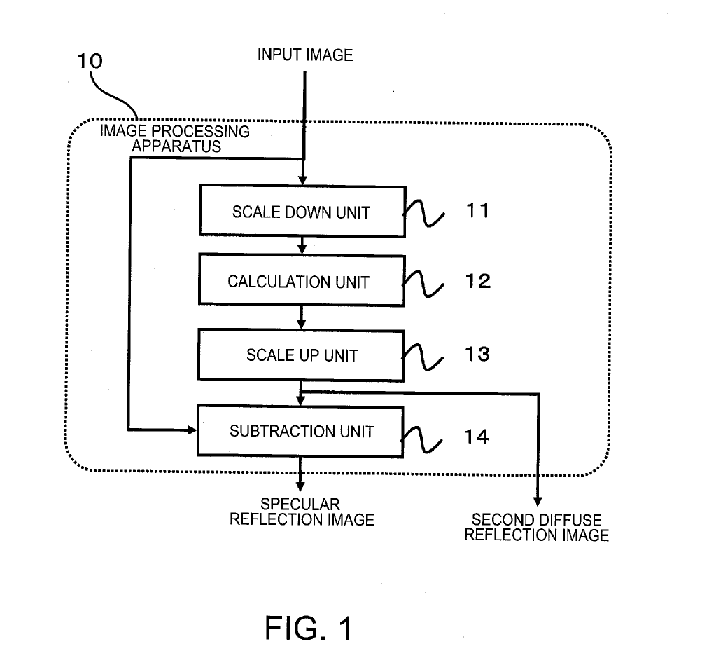

FIG. 1 is a block diagram of an image processing apparatus 10 according to a first embodiment. The image processing apparatus 10 includes a scale down unit 11, a calculation unit 12, a scale up unit 13, and a subtraction unit 14. As to the image processing apparatus 10, from an input image, an image (Hereinafter, it is called “a diffuse reflection image”) having pixel values due to a diffuse reflection component and an image (Hereinafter, it is called “a specular reflection image”) having pixel values due to a specular reflection component are separated.

The input image includes pixel values of each pixel. For example, the pixel value includes a brightness signal and a color signal based on a standard of International Telecommunication Union (Hereinafter, it is called “ITU”). This standard may be any of a system that components are three primary colors “RGB” and a system that RGB is converted to the brightness signal and the color signal. In the first embodiment, as one example, the system that components are “RGB” corresponding to three primary colors of ITU-RBT.601 standard is explained. Accordingly, a pixel value of each pixel in the input image is represented by R channel having a brightness of red component, G channel having a brightness of green component, and B channel having a brightness of blue component. Here, R channel has a discrete pixel value 0˜r₀, G channel has a discrete pixel value 0˜g₀, and B channel has a discrete pixel value 0˜b₀.

A reflection light from an object (subject) is due to two physical different routes. As a first one, the light is reflected by a boundary of a surface of the object, and this reflection is called a specular reflection. As a second one, the reflection light is due to disperse of an incident light onto irregularity of the surface of the object, and this reflection is called a diffuse reflection. The diffuse reflection light includes a color (different from a light source color) peculiar to the surface of the object.

The scale down unit 11 scales down the input image to calculate an image having a smaller size than the input image. This size indicates the number of pixels included in one image (frame or field), and the scaled down image includes pixels of which the number is fewer than that of the input image. The scaled down image is sent to the calculation unit 12.

The calculation unit 12 extracts pixel values of the diffuse reflection component of each pixel from the scaled down image, and calculates a first diffuse reflection image having the same size as the scaled down image. The first diffuse reflection image is sent to the scale up unit 13.

The scale up unit 13 calculates a second diffuse reflection image having the same size as the input image by scaling up the first diffuse reflection image. The second diffuse reflection image is sent to the subtraction unit 14. Furthermore, the second diffuse reflection image is output.

The subtraction unit 14 generates a specular reflection image by subtracting the second diffuse reflection image from the input image. Furthermore, the specular reflection image is output as an image having the specular reflection component separated from the input image.

Moreover, in the first embodiment, a component to calculate/output both the diffuse reflection image and the specular reflection image is explained. However, the component may output any of both the diffuse reflection image and the specular reflection image.

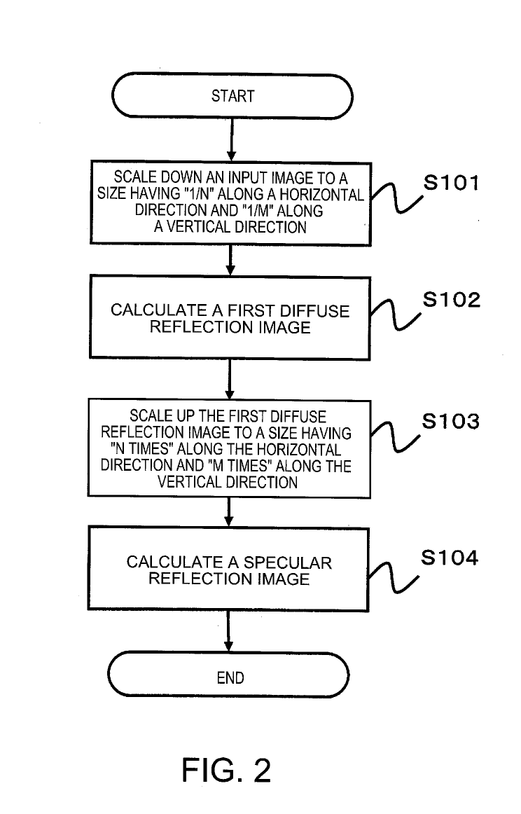

Next, operation of the image processing apparatus 10 is explained by referring to FIG. 2.

The scale down unit 11 scales down an input image to a size having “1/N” along a horizontal direction and “1/M” along a vertical direction (S101). The method for scaling down may be a general method thereof such as the nearest neighbor algorithm or the bicubic interpolation algorithm. When the input image is scaled down, a method hard to mix colors of pixels adjacent to a target pixel had better be used. Because, if colors of adjacent pixels are mixed with a color of the target pixel, when the calculation unit 12 calculates a first diffuse reflection image at post processing, accuracy to separate the first diffuse reflection image from the input image falls. In the scale down method of the first embodiment, an example using the nearest neighbor algorithm is explained. The nearest neighbor algorithm is the method hard to mix colors of pixels adjacent to a target pixel.

In the first embodiment, scaling down by the nearest neighbor algorithm is applied to color components of R channel, B channel and G channel, respectively. As a result, a scaled down image having pixels of which colors are not mixed with colors of adjacent pixels can be generated.

From the above scaled down image, the calculation unit 12 calculates a pixel value of a diffuse reflection component of each pixel in the scaled down image, and generates a first diffuse reflection image having the same size as the scaled down image (S102). Here, in order to calculate the first diffuse reflection image, any calculation method may be used. In the first embodiment, a method disclosed by S. A. Shafer, “Using color to separate reflection components”, in COLOR Research and Application, Vol. 10, No. 4, pp. 210-218, 1985, is used (Hereinafter, this document is called “non-patent reference 1”).

Specifically, in the method by S. A. Shafer, by using a target pixel and a hue (normalized ratio of RGB value) of pixels adjacent to the target pixel in the input image, pixels on the same surface are calculated. Next, by using each pixel value of the pixels on the same surface, a typical chromaticity of the pixels on the same surface is calculated. Next, by using the target pixel value and the typical chromaticity of the pixels on the same surface, a diffuse reflection ratio of the target pixel is calculated. Then, by using a pixel value of the target pixel and the diffuse reflection ratio, a specular reflection image and a diffuse reflection image of the target pixel are calculated and output.

However, in general, when the diffuse reflection image is calculated by above-mentioned method, color information of pixels adjacent to each target pixel must be referred. Accordingly, if the number of target pixels more increases, i.e., a size of the image is larger, a calculation amount thereof becomes more enormous. On the other hand, at S101, the number of target pixels can be reduced. Accordingly, the calculation amount thereof can more lessen. In this case, at S102, if the number of times of calculation to generate the diffuse reflection component of each target pixel in the input image (size thereof is not changed) is P, the number of times of calculation can be reduced to P/(N×M).

The scale up unit 13 scales up the first diffuse reflection image (output by the calculation unit 12) to a size having “N times” along the horizontal direction and “M times” along the vertical direction, and generates a second diffuse reflection image having the size (S103). The method for scaling up may be a general method thereof such as the nearest neighbor algorithm or the bicubic interpolation algorithm. This method had better generate a scaled up image having sharpness as much as possible. Because, at S104 as post processing, when the subtraction unit 14 subtracts the second diffuse reflection image from the input image, error of an edge part (occurred by scaling up) and a texture having variation of brightness must be reduced. Accordingly, in the first embodiment, a scale up method for supplementing pixel values by the bicubic interpolation algorithm is used. The bicubic interpolation algorithm is a method for calculating a polynomial interpolation equation by using sixteen sampling points (pixels) adjacent to the target point when the first diffuse reflection image is scaled up. By the bicubic interpolation algorithm, a scaled up image having sharpness can be generated. In the first embodiment, the scale up method for supplementing pixel values by the bicubic interpolation algorithm is applied to color components of R channel, B channel and G channel of the first diffuse reflection image, respectively. As a result, the second diffuse reflection image of which errors of edge parts are few compared with the input image can be calculated.

At S101˜S103, by scaling up the first diffuse reflection image having small size, the second diffuse reflection image having the same size as the input image can be acquired while the number of times of calculation thereof is reduced.

The subtraction unit 14 calculates a specular reflection image by subtracting the second diffuse reflection image from the input image (S104). If the specular reflection image is represented as “Spec”, a pixel value “Spec (x,y)” of the specular reflection image is calculated by following equation.

Spec(x,y)=IN(x,y)−DIFF(x,y) (1)

In the equation (1), “IN(x,y)” represents a pixel value of the input image, and “DIFF(x,y)” represents a pixel value of the second diffuse reflection image. In the first embodiment, the equation (1) is applied to each color component of R channel, B channel and G channel of the diffuse reflection image, respectively.

In the dichromatic reflection model proposed by S. A. Shafer, a color on a surface of the object is represented by linearly adding a brightness of the specular reflection image to a brightness of the diffuse reflection image. Accordingly, at S104, by subtracting a diffuse reflection component (as an original color element on the surface of the object) from each channel of each pixel of the input image, color components that a light source is specular-reflected are remained, which are the specular reflection image.

As mentioned-above, diffuse reflection on a surface of the object occurs by scattering of an incident light onto irregularity of the surface thereof. Furthermore, in many cases, irregularity of the surface of the object is continuous in a spatial direction, and reflection intensity thereof smoothly changes along the spatial direction. Accordingly, a brightness change of the diffuse reflection image is often extracted as a low frequency component. Furthermore, even if a smooth image having the low frequency component is scaled down and up, a frequency property thereof hardly changes, and the smooth image has almost the same frequency property as that calculated from the image without scaling down and up.

At S101˜S103, when a diffuse reflection image is calculated from the scaled down image, the diffuse reflection image having the same frequency property as that calculated from the input image can be calculated. In this case, the diffuse reflection image is calculated from the scaled down image. Accordingly, the number of times of calculation thereof can be reduced. Furthermore, by scaling down and up, a noise of each pixel of the input image is redacted. As a result, the diffuse reflection image having fewer noises than a diffuse reflection image calculated without scaling down and up can be calculated.

Furthermore, the specular reflection component has many high frequency components. If scale up processing is executed after the first diffuse reflection image is subtracted from the scaled down image, a specular reflection image having low sharpness is generated. Accordingly, in the first embodiment, the second diffuse reflection image is subtracted from the input image. As a result, the specular reflection image having high sharpness is generated while the high frequency component thereof is remained.

As to the target pixel, the diffuse reflection component and the specular reflection component can be separated with few calculation amounts. Accordingly, the first embodiment is effective for a use to separate the diffuse reflection component and the specular reflection component from a large number of images in a short time, such as an image sequence. Furthermore, by using the diffuse reflection component and the specular reflection component of the target pixel, an object recognition having high accuracy can be performed at post stage.

Furthermore, the diffuse reflection component and the specular reflection component may be applied to a use to emphasize the image. For example, after expanding the specular reflection component, by synthesizing the diffuse reflection component with the expanded specular reflection component again, an apparent gloss on the surface of the object can be emphasized. Furthermore, after reducing the specular reflection component, by synthesizing the diffuse reflection component with the reduced specular reflection component again, the specular reflection component can be reduced such as a use for person's face. In the first embodiment, the diffuse reflection component and the specular reflection component of the target pixel can be separated with few calculation amounts. Accordingly, the first embodiment is useful for a previous phase of such emphasis processing. Furthermore, the first embodiment is effective for general purpose image processing of an imaging device (such as a camera, a sensor) and a display device (such as a television, a display).

### The Second Embodiment

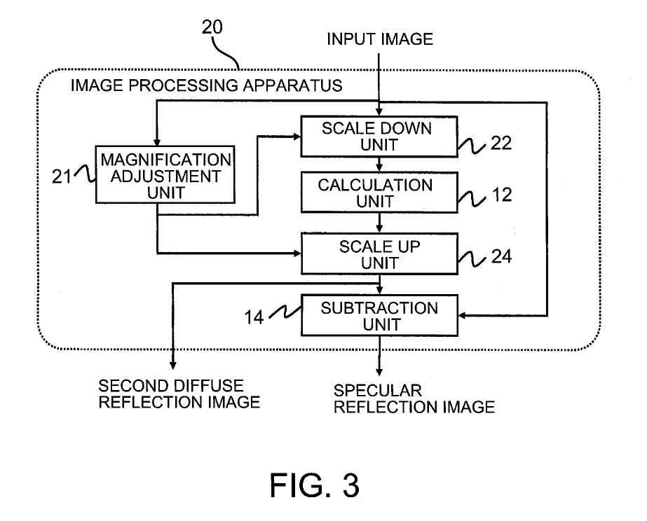

FIG. 3 is a block diagram of an image processing apparatus 20 of the second embodiment. The image processing apparatus 20 includes a magnification adjustment unit 21, a scale down unit 22, the calculation unit 12, a scale up unit 24, and the subtraction unit 14.

The magnification adjustment unit 21 acquires information related to a size of the input image, and calculates a scale down ratio so that a size of the scaled down image (by the scale down unit 22) is equal to a specific first size. By using a size of the input image, the magnification adjustment unit 21 calculates a magnification “N0” along a horizontal direction and a magnification “M0” along a vertical direction of the image, and sends the magnifications to the scale down unit 22 and the scale up unit 24. Assume that a size along the horizontal direction of the input image is N and a size along the vertical direction thereof is M. Here, the magnifications N0 and m0 had better satisfy following equations.

N0=N/sN

M0=M/sM (2)

In above equations, “sN” is a constant representing a size along the horizontal direction of the scaled down image, and “sM” is a constant representing a size along the vertical direction thereof. The magnification adjustment unit 21 calculates respective magnifications so that a size (the specific first size) along the horizontal axis is equal to “sN” and a size (the specific first size) along the vertical axis is equal to “sM”.

By using the magnifications N0 and M0, the scale down unit 22 scales down the input image to a size having 1/N0 along the horizontal direction and 1/M0 along the vertical direction.

By using the magnifications N0 and M0, the scale up unit 24 scales up the first diffuse reflection image to a size having N0 along the horizontal direction and M0 along the vertical direction, and generates a second diffuse reflection image. The second diffuse reflection image is sent to the subtraction unit 14.

As mentioned-above, as to the second embodiment, a scale down ratio and a scale up ratio are adjusted based on a size of the input image. In the image processing apparatus, input images having various sizes are processed. In the second embodiment, a size of the first diffuse reflection image processed by the calculation unit 12 is fixed. Briefly, even if sizes of the input images are different, only one calculation circuit for the processing part is used. As a result, a manufacture cost of the apparatus can be lowered.

In the second embodiment, the diffuse reflection component and the specular reflection component may be applied to a use to emphasize the image. For example, after expanding the specular reflection component, by synthesizing the diffuse reflection component with the expanded specular reflection component again, an apparent gloss on the surface of the object can be emphasized. Furthermore, after reducing the specular reflection component, by synthesizing the diffuse reflection component with the reduced specular reflection component again, the specular reflection component can be reduced such as a use for person's face. In the second embodiment, processing for the input image having various sizes can be realized with low manufacture cost. Accordingly, the second embodiment is effective for general purpose image processing of an imaging device (such as a camera, a sensor) and a display device (such as a television, a display).

### The Third Embodiment

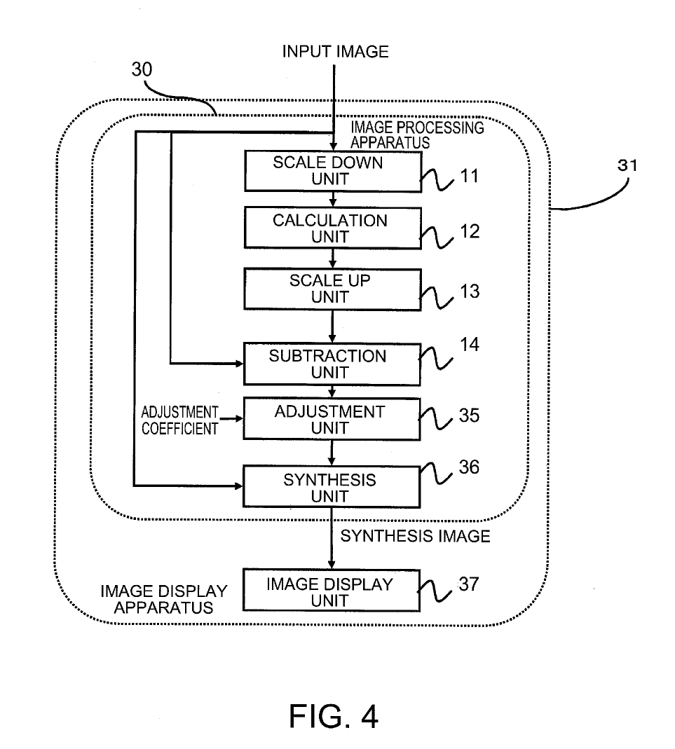

FIG. 4 is a block diagram of an image display apparatus 31 of the third embodiment. The image display apparatus 31 includes an image processing apparatus 30 and an image display unit 37. The image processing apparatus 30 includes the scale down unit 11, the calculation unit 12, the scale up unit 13, the subtraction unit 14, an adjustment unit 35, and a synthesis unit 36.

The scale up unit 13 sends the second diffuse reflection image to the subtraction unit 14. Processing to calculate the second diffuse reflection image is same as that of the first embodiment. Accordingly, explanation thereof is omitted.

By using the input image and the second diffuse reflection image, the subtraction unit 14 subtracts the second diffuse reflection image from the input image, and calculates a specular reflection image. The specular reflection image is sent to the adjustment unit 35. Processing to calculate the specular reflection image is same as that of the first embodiment. Accordingly, explanation thereof is omitted.

The adjustment unit 35 calculates an adjustment image by adjusting a brightness of the specular reflection image with an adjustment coefficient. The adjustment image is sent to the synthesis unit 36.

The synthesis unit 36 calculates a synthesis image by adding the input image to the adjustment image, and outputs the synthesis image. The image display unit 37 displays the synthesis image.

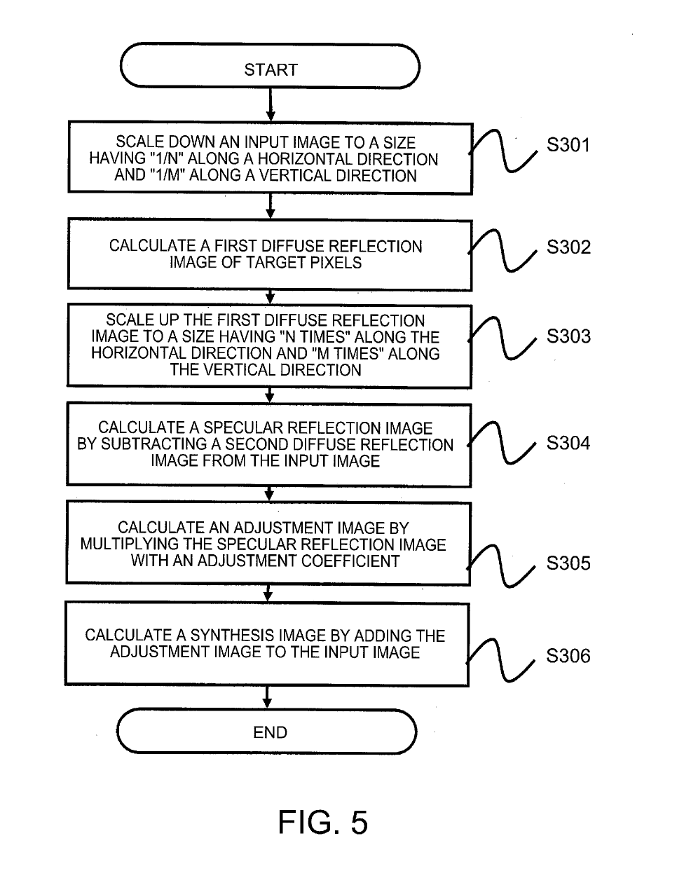

FIG. 5 is a flow chart of operation of the image processing apparatus 30. In FIG. 5, processing of S301˜S304 is same as that of S101˜S104 in FIG. 2. Accordingly, explanation thereof is omitted.

The adjustment unit 35 adjusts a brightness of the specular reflection image with the adjustment coefficient, and generates the adjustment image (S305). Assume that a pixel value of the specular reflection image at a pixel position (x,y) is Spec(x,y) and a pixel value of the adjustment image at a pixel position (x,y) is eSpec(x,y). Following equation is for calculating eSpec(x,y).

eSpec(x,y)=gain×Spec(x,y) (3)

In the equation (3), “gain” is the adjustment coefficient. In the image processing apparatus 30, when an image to emphasize a specular reflection component (apparent gloss) of the input image is output, an actual number larger than (or equal to) “0” is set as the adjustment coefficient. Specifically, by setting as “gain=1.0”, a synthesis image having two times of brightness of the specular reflection component of the input image is output. Furthermore, in the image processing apparatus 30, when an image to reduce the specular reflection component of the input image is output, an actual number smaller than (or equal to) “0” and larger than (or equal to) “−1” is set as the adjustment coefficient.

For example, by setting as “gain=−1.0”, a synthesis image excluding the specular reflection component of the input image is output. The adjustment coefficient “gain” may be set at shipment time from the factory or may be set by an external input from the user.

The synthesis unit 36 calculates the synthesis image by adding the adjustment image to the input image (S306). A pixel value eOUT(x,y) of the synthesis image at a pixel position (x,y) is calculated by following equation.

eOUT(x,y)=IN(x,y)+eSpec(x,y) (4)

In the equation (4), as to a first term and a second term of the right side, the pixel value is desirably maintained as a value linear to the brightness. However, it may be a non-linear signal value subjected to gamma transform. As to dichromatic reflection model disclosed in non-patent reference 1, if the pixel value is linear to a physical brightness, additivity is satisfied between the diffuse reflection image and the specular reflection image. However, if the pixel value is non-linear signal value, strictly speaking, it does not depend on dichromatic reflection model. However, in this case, effect to adjust apparent gloss by the third embodiment can be realized. Accordingly, the pixel value may be maintained as non-linear signal value. Calculation by the equation (4) is applied to R channel, B channel and G channel of each pixel value of the input image, respectively.

As mentioned-above, in the third embodiment, a brightness of the specular reflection image (acquired by the same component as the first embodiment) can be arbitrarily adjusted. By synthesizing the input image with the adjustment image, while calculation amount to separate the specular reflection component is reduced, an image which the specular reflection component of the input image is variously adjusted can be displayed.

In a general image display apparatus or a general image recording apparatus, for example, such as a signal strict mode, the input image is output (as it is) not by adjusting the specular reflection component thereof. Contrary to this, in the third embodiment, by setting “gain=0” in the equation (3), the input image can be output (as it is) not by adjusting the specular reflection component.

From above-mentioned reason, the image processing apparatus of the third embodiment is effective for general purpose image processing of an imaging device (such as a camera, a sensor) and a display device (such as a television, a display).

### The Fourth Embodiment

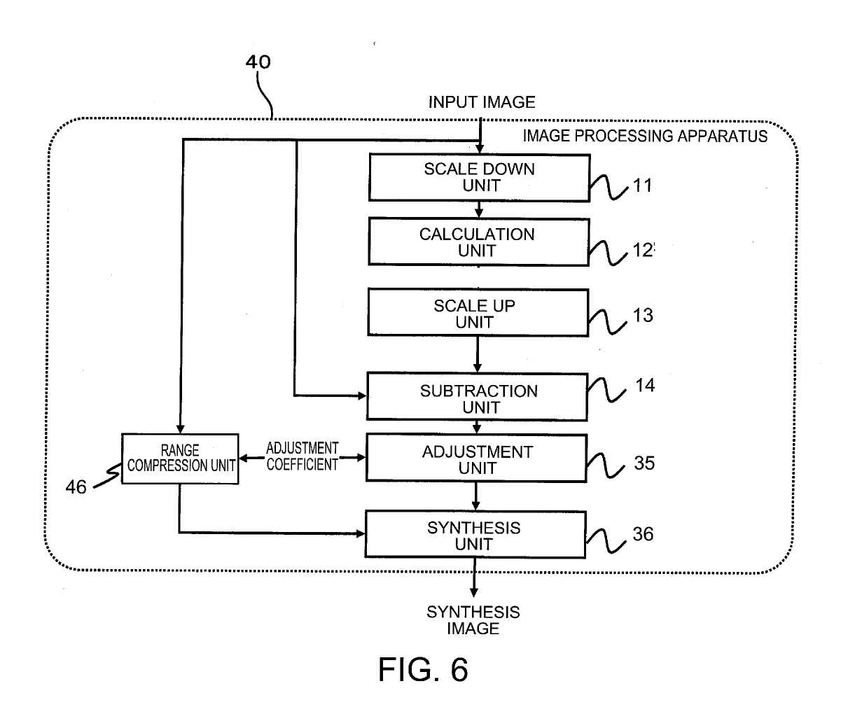

FIG. 6 is a block diagram of an image processing apparatus 40 of the fourth embodiment. The image processing apparatus 40 includes the scale down unit 11, the calculation unit 12, the scale up unit 13, the subtraction unit 14, the adjustment unit 35, a range compression unit 46, and the synthesis unit 36. Hereinafter, the range compression unit 46 is explained.

The range compression unit 46 compresses a range of brightness of the input image based on the adjustment coefficient, and calculates an compression input image. The range compression unit 46 sent the compression input image to the synthesis unit 36. The range compression unit 46 calculates a pixel value cIN(x,y) of the compression input image by following equation.

cIN(x,y)=C×IN(x,y)/gain, gain>0

cIN(x,y)=IN(x,y), gain<=0 (5)

In the equation (5), “IN(x,y)” represents a pixel value of the input image at a pixel position (x,y), “gain” is the adjustment coefficient (used by the adjustment unit 35) of the specular reflection image, and “C” is a constant arbitrarily set. Calculation of the equation (5) is applied to R channel, B channel and G channel of each pixel value of the input image, respectively.

The synthesis unit 36 calculates a synthesis image by adding the compression input image to the adjustment image. In the fourth embodiment, after the adjustment image which brightness of the specular reflection image is adjusted is calculated, by adding the compression input image to the adjustment image, the synthesis image is calculated. In this case, when a value of “gain” is larger, whiteout condition often occurs at a highlight part of the synthesis image to be finally output. Because, the highlight part (by the specular reflection component in the input image) originally has a value near an upper limit of a range of brightness to be imaged, and the specular reflection image is added to this highlight part.

Contrary to this, in the fourth embodiment, as a value of “gain” is larger, i.e., as a brightness level of the specular reflection image is higher, a brightness of the input image is more compressed by the equation (5). Accordingly, the whiteout condition is hard to occur.

On the other hand, if a value of “gain” is smaller than (or equal to) “0”, the whiteout condition does not originally occur. Accordingly, range compression of the input image by the equation (5) had better be not performed.

In the fourth embodiment, a range of brightness of the input image is linearly compressed based on the adjustment coefficient. However, if the method is for generally compressing the range of brightness, any method may be used. Specifically, a method for compressing by using logarithmic pixel values, a method for compressing the range by using feature (such as a maximum, a median, a minimum) of pixel values, and, by separating a low frequency component and a high frequency component of the image, a method for compressing a brightness of at least one thereof, may be used.

In a general image display apparatus and a general image recording apparatus, when the whiteout condition occurs at the highlight part in the image, image quality thereof falls. However, in the fourth embodiment, even if the specular reflection image is brighter, the synthesis image hard to occur the whiteout condition at the highlight part can be generated. Accordingly, the fourth embodiment is effective for general purpose image processing of an imaging device (such as a camera, a sensor) and a display device (such as a television, a display).

### The Fifth Embodiment

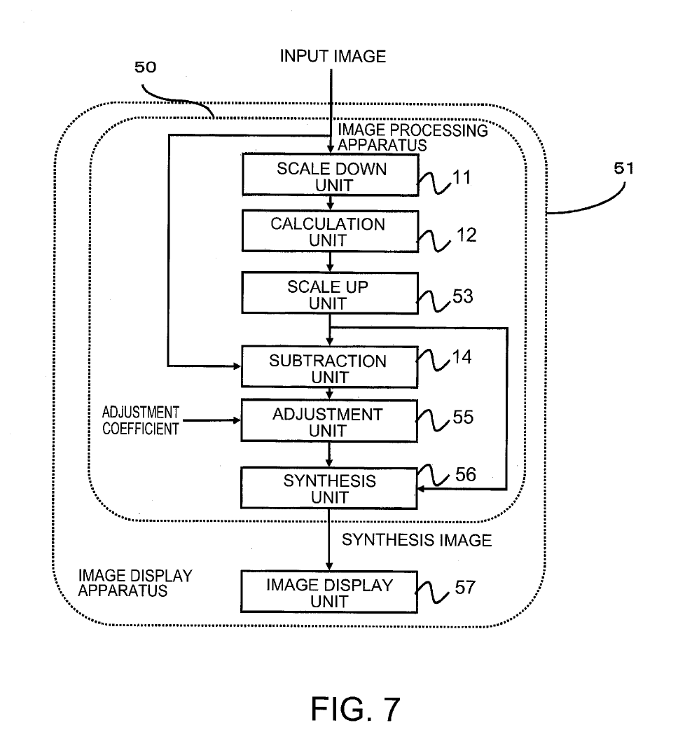

FIG. 7 is a block diagram of an image display apparatus 51 of the fifth embodiment. The image display apparatus 51 includes an image processing apparatus 50 and an image display unit 57. The image processing apparatus 50 includes the scale down unit 11, the calculation unit 12, a scale up unit 53, the subtraction unit 14, an adjustment unit 55, and a synthesis unit 56.

The scale up unit 53 scales up the first diffuse reflection image to the same size as the input image, and generates a second diffuse reflection image as the scaled up image. The second diffuse reflection image is sent to the subtraction unit 14 and the synthesis unit 56.

The adjustment unit 55 calculates an adjustment image by adjusting a brightness of the specular reflection image with the adjustment coefficient. The adjustment image is sent to the synthesis unit 56.

The synthesis unit 56 generates a synthesis image by adding the second diffuse reflection image to the adjustment image, and outputs the synthesis image. The image display unit 57 displays the synthesis image.

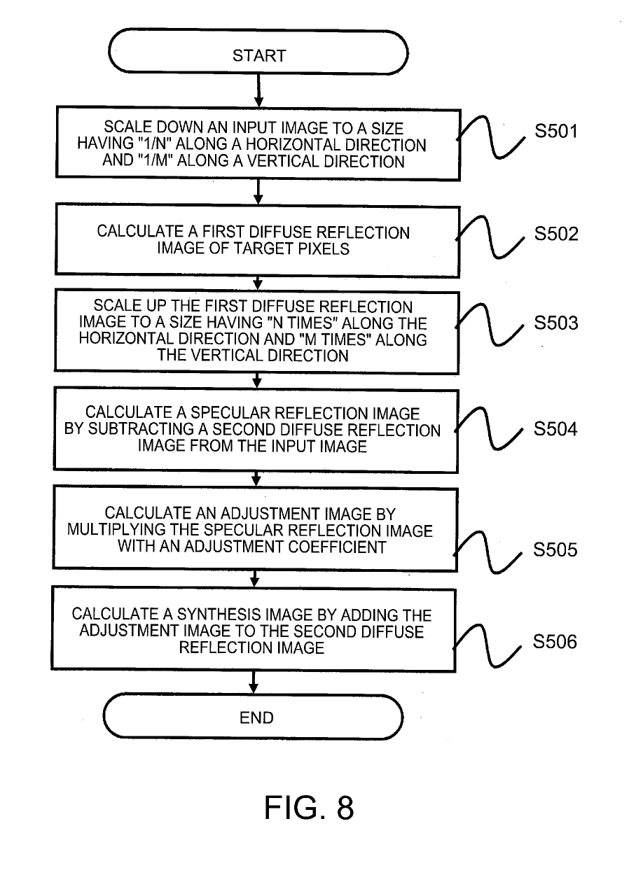

FIG. 8 is a flow chart of operation of the image processing apparatus 50. In FIG. 5, processing of S501, S502 and S504 is same as that of S101, S102 and S104 in FIG. 2. Accordingly, explanation thereof is omitted.

The scale up unit 53 scales up the first diffuse reflection image (output by the calculation unit 12) to a size having “N times” along the horizontal direction and “M times” along the vertical direction, and generates a second diffuse reflection image as a scaled up image (S503). The second diffuse reflection image is sent to the subtraction unit 14 and the synthesis unit 56.

The adjustment unit 55 calculates an adjustment image by adjusting a brightness of the specular reflection image with a adjustment coefficient (S505). Assume that a pixel value of the specular reflection image at a pixel position (x,y) is Spec(x,y) and a pixel value of the adjustment image at a pixel position (x,y) is eSpec2(x,y). Following equation is for calculating eSpec2(x,y).

eSpec2(x,y)=gain×Spec(x,y) (6)

In the equation (6), “gain” is the adjustment coefficient. In the image processing apparatus 50, when an image to expand a specular reflection component (apparent gloss) of the input image is output, an actual number larger than (or equal to) “1” is set as the adjustment coefficient. Specifically, by setting as “gain=2.0”, a synthesis image having two times of brightness of the specular reflection component of the input image is output. Furthermore, in the image processing apparatus 50, when an image to reduce the specular reflection component of the input image is output, an actual number smaller than (or equal to) “1” and larger than (or equal to) “0” is set as the adjustment coefficient. For example, by setting as “gain=0.0”, a synthesis image excluding the specular reflection component of the input image is output. The adjustment coefficient “gain” may be set at shipment time from the factory or may be set by an external input from the user.

The synthesis unit 56 calculates the synthesis image by adding the adjustment image to the second diffuse reflection image (S506). A pixel value eOUT2(x,y) of the synthesis image at a pixel position (x,y) is calculated by following equation.

eOUT2(x,y)=DIFF(x,y)+eSpec2(x,y) (7)

In the equation (7), “DIFF(x,y)” represents a pixel value of the second diffuse reflection image at a pixel position (x,y).

In the equation (7), as to a first term and a second term of the right side, the pixel value is desirably maintained as linear to the brightness. However, it may be a non-linear signal value subjected to gamma transform. As to dichromatic reflection model as mentioned-above, if the pixel value is linear to a physical brightness, additivity is satisfied between the diffuse reflection image and the specular reflection image. However, if the pixel value is non-linear signal value, strictly speaking, it does not depend on dichromatic reflection model. However, in this case, effect to adjust apparent gloss by the fifth embodiment can be realized. Accordingly, the pixel value may be maintained as non-linear signal value. Calculation by the equation (7) is applied to R channel, B channel and G channel of each pixel value of the input image.

The second diffuse reflection image is an image by scaling up the first diffuse reflection image acquired after scaling down the input image. Here, when the input image is scaled down, fine color noises included in input image is removed. Accordingly, in the fifth embodiment, by synthesizing the second diffuse reflection image with the adjustment image, a clear image having the specular reflection component variously adjusted can be displayed while the noise included in the input image is removed, respectively.

From above-mentioned reason, the image processing apparatus of the fifth embodiment is effective for general purpose image processing of an imaging device (such as a camera, a sensor) and a display device (such as a television, a display).

### The Sixth Embodiment

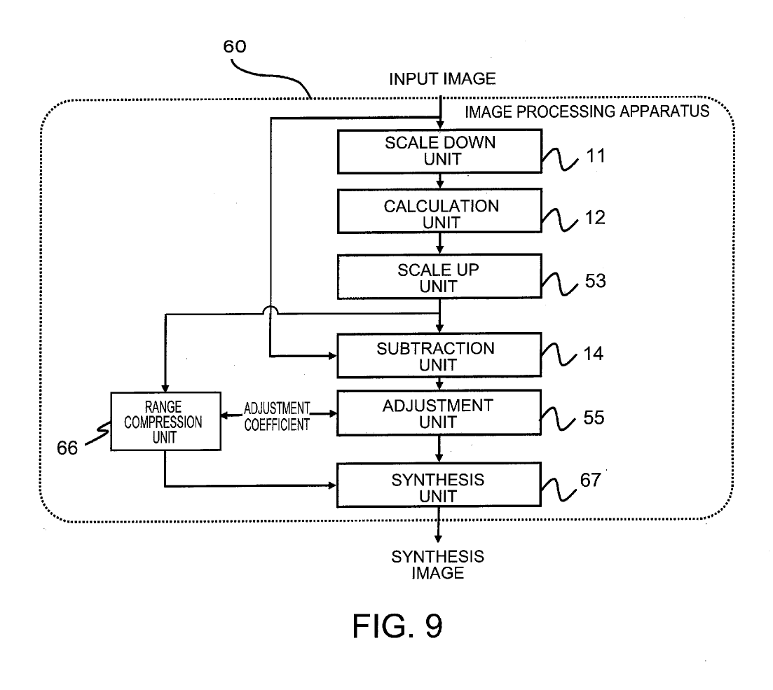

FIG. 9 is a block diagram of an image processing apparatus 60 of the sixth embodiment. The image processing apparatus 60 includes the scale down unit 11, the calculation unit 12, the scale up unit 53, the subtraction unit 14, the adjustment unit 35, a range compression unit 66 and a synthesis unit 67.

The range compression unit 66 calculates a compression diffuse reflection image by compressing a range of brightness of the second diffuse reflection image based on the adjustment coefficient. The range compression unit 66 sends the compression diffuse reflection image to the synthesis unit 67. The range compression unit 66 calculates a pixel value cDIFF(x,y) of the compression diffuse reflection image by following equation.

cDIFF(x,y)=C×DIFF(x,y)/gain, gain>1

cDIFF(x,y)=DIFF(x,y), gain<=1 (8)

In the equation (8), “DIFF(x,y)” represents a pixel value of the input image at a pixel position (x,y), “gain” is the adjustment coefficient (used by the adjustment unit 55) of the specular reflection image, and “C” is a constant arbitrarily set. Calculation of the equation (8) is applied to R channel, B channel and G channel of each pixel value of the input image, respectively.

The synthesis unit 67 calculates a synthesis image by adding the compression diffuse reflection image to the adjustment image.

In the sixth embodiment, after the adjustment image which brightness of the specular reflection image is adjusted is calculated, by adding the compression diffuse reflection image to the adjustment image, the synthesis image is calculated. In this case, when a value of “gain” is larger, whiteout condition often occurs at a highlight part of the synthesis image to be finally output. Because, a diffuse reflection component adjacent to the highlight part is relatively bright, the specular reflection image is added to this highlight part.

Contrary to this, in the sixth embodiment, as a value of “gain” is larger, i.e., as a brightness level of the specular reflection image is higher, a brightness of the second diffuse reflection image is more compressed by the equation (8). Accordingly, the whiteout condition is hard to occur.

On the other hand, if a value of “gain” is smaller than (or equal to) “1”, the whiteout condition is originally hard to occur. Accordingly, range compression of the input image by the equation (8) had better be not performed.

In the sixth embodiment, a range of brightness of the second diffuse reflection image is linearly compressed based on the adjustment coefficient. However, if the method is for generally compressing the range of brightness, any method may be used. Specifically, a method for compressing by using logarithmic pixel values, a method for compressing the range by using feature (such as a maximum, a median, a minimum) of pixel values, and, by separating a low frequency component and a high frequency component of the image, a method for compressing a brightness of at least one thereof, may be used.

In a general image display apparatus and a general image recording apparatus, when the whiteout condition occurs at the highlight part in the image, image quality thereof falls. However, in the sixth embodiment, even if the specular reflection image is brighter, the synthesis image hard to occur the whiteout condition at the highlight part can be generated. Accordingly, the sixth embodiment is effective for general purpose image processing of an imaging device (such as a camera, a sensor) and a display device (such as a television, a display).

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An apparatus for processing an image, comprising:
a scale down unit to generate a scaled down image by scaling down a target image, the scaled down image having a size smaller than the target image;
a calculation unit configured to calculate a pixel value of a diffuse reflection component of each pixel in the scaled down image, and to generate a first diffuse reflection image having the pixel value and the same size as the scaled down image;
a scale up unit to generate a second diffuse reflection image by scaling up the first diffuse reflection image, the second diffuse reflection image having the same size as the target image; and
a subtraction unit configured to generate a specular reflection image by subtracting the second diffuse reflection image from the target image.

2. The apparatus according to claim 1, further comprising:
an adjustment unit configured to adjust a brightness of the specular reflection image based on an adjustment coefficient; and
a synthesis unit configured to generate a synthesis image by adding the target image to the specular reflection image having the brightness adjusted.

3. The apparatus according to claim 2, further comprising:
a range compression unit configured to generate a compression image by compressing a range of each pixel value of the target image based on the adjustment coefficient;
wherein the synthesis unit generates a synthesis image by adding the compression image to the specular reflection image having the brightness adjusted.

4. The apparatus according to claim 1, further comprising:
a magnification adjustment unit configured to calculate a magnification to scale down the target image to a specific first size by acquiring a size of the target image;
wherein the scale down unit scales down the target image based on the magnification.

5. The apparatus according to claim 1,
wherein the scale down unit generates the scaled down image by using the nearest neighbor algorithm.

6. An apparatus for displaying an image, comprising:
an image processing apparatus of claim 1; and
a display unit to display the image.

7. The apparatus according to claim 6,
wherein the image processing apparatus further comprises
an adjustment unit configured to adjust a brightness of the specular reflection image based on an adjustment coefficient; and
a synthesis unit configured to generate a synthesis image by adding the target image to the specular reflection image having the brightness adjusted.

8. The apparatus according to claim 7,
wherein the image processing apparatus further comprises
a range compression unit configured to generate a compression image by compressing a range of each pixel value of the target image based on the adjustment coefficient;
wherein the synthesis unit generates a synthesis image by adding the compression image to the specular reflection image having the brightness adjusted.

9. The apparatus according to claim 6,
wherein the image processing apparatus further comprises
a magnification adjustment unit configured to calculate a magnification to scale down the target image to a specific first size by acquiring a size of the target image;
wherein the scale down unit scales down the target image based on the magnification.

10. The apparatus according to claim 6,
wherein the scale down unit generates the scaled down image by using the nearest neighbor algorithm.

11. A method for processing an image, comprising:
generating a scaled down image by scaling down a target image, the scaled down image having a size smaller than the target image;
calculating a pixel value of a diffuse reflection component of each pixel in the scaled down image;
generating a first diffuse reflection image having the pixel value and the same size as the scaled down image;
generating a second diffuse reflection image by scaling up the first diffuse reflection image, the second diffuse reflection image having the same size as the target image; and
generating a specular reflection image by subtracting the second diffuse reflection image from the target image.
